(19) United States
(12) Patent Application Publication
(10) Pub. No.: US 2024/0188075 A1
(43) Pub. Date: Jun. 6, 2024

(54) COMMUNICATION APPARATUSES AND COMMUNICATION METHODS FOR OPTIMISING TIME DOMAIN WINDOW AND DMRS FOR JOINT CHANNEL ESTIMATION

(71) Applicant: Panasonic Intellectual Property Corporation of America, Torrance, CA (US)

(72) Inventors: Xuan Tuong TRAN, Singapore (SG); Tetsuya YAMAMOTO, Kanagawa (JP); Hong Cheng, Michael SIM, Singapore (SG); Yang KANG, Singapore (SG); Akihiko NISHIO, Osaka (JP); Yoshihiko OGAWA, Kanagawa (JP); Tiong Hou TEO, Singapore (SG)

(21) Appl. No.: 18/553,164

(22) PCT Filed: Jan. 17, 2022
(86) PCT No.: PCT/SG2022/050013

§ 371 Date: Sep. 28, 2023

(30) Foreign Application Priority Data
Apr. 6, 2021 (SG) 10202103526T

(51) Int. Cl. H04W 72/1268; H04L 5/00; H04W 72/0446; H04W 72/51; H04W 76/20

(52) U.S. Cl. CPC H04W 72/1268; H04L 5/0012; H04W 72/0446; H04W 72/51; H04W 76/20

(57) ABSTRACT

The present disclosure provides communication apparatuses and communication methods for optimising time domain window and demodulation reference signal (DMRS) for joint channel estimation. The communication apparatuses include a communication apparatus comprising: circuitry which, in operation, determines one or more time domain windows for multiple physical uplink shared channel (PUSCH) transmissions, each length of the one or more time domain windows being not more than an overall length of the multiple PUSCH transmissions; and a transmitter, which in operation, transmits reference signals based on the one or more time domain windows.

### TECHNICAL FIELD

The following disclosure relates to communication apparatuses and communication methods for optimising time domain window, and more particularly to communication apparatuses and communication methods for optimising time domain window and demodulation reference signal (DMRS) for joint channel estimation.

### BACKGROUND

Every cellular operation considers that coverage is one of the key factors when commercializing cellular communication networks due to its direct impact on service quality, capital expenditures, and operating expenses. Many countries are making available more spectrum in frequency range 1 (FR1), such as 3.5 GHz, which is typically in higher frequencies than that used for Long-Term Evolution (LTE) or 3G. Compared to LTE, 5G new radio (NR) is designed to operate at much higher frequencies such as 28 GHz or 39 GHz in frequency range 2 (FR2). Due to the higher frequencies, it is inevitable that the wireless channel will be subject to higher path-loss such that it is more challenging to maintain an adequate quality of service that is at least equal to that of legacy radio access technologies (RATs). One key user equipment (UE) application of particular importance is voice service for which a typical subscriber will always expect a ubiquitous coverage wherever it is located.

In release (Rel.)-17, a study item “Study on NR coverage enhancements” was proposed to evaluate the baseline performance for both FR1 and FR2. The following channels have been identified as the potential bottleneck channels for FR1 as shown in the 3rd Generation Partnership Project (3GPP) technical report (TR) 38.830:
1 st priority
   Physical Uplink Shared Channel (PUSCH) for enhanced Mobile Broadband (eMBB) (for frequency division duplexing (FDD) and time division duplexing TDD with slot formats DDDSU, DDDSUDDSUU and DDDDDDDSUU)
   PUSCH for voice over internet protocol (VoIP) (for FDD and TDD with slot formats DDDSU, DDDSUDDSUU)
2nd priority
   Physical Random Access Channel (PRACH) format B4
   PUSCH of Msg.3
   Physical Uplink Control Channel (PUCCH) format 1
   PUCCH format 3 with 11 bit
   PUCCH format 3 with 22 bit
   Broadcast Physical Downlink Shared Channel (PDCCH) (gNB with 24 dBm/MHz Tx power)

The following channels have been identified as the potential bottleneck channels for Urban 28 GHz scenario:
PUSCH eMBB (slot formats DDDSU and DDSU)
PUSCH VoIP (slot formats DDDSU and DDSU)
PUCCH format 3 11 bits
PUCCH format 3 22 bits
PRACH format B4
PUSCH of message 3 (Msg3)

The Rel.17 study item “Study on NR coverage enhancements” studied the enhancements for PUSCH, PUCCH and other channels/signals. The enhancements for PUSCH, PUCCH and Msg3 PUSCH were proposed to be specified in Rel.17 coverage enhancements working item (WI) for both FR1 and FR2, as well as TDD and FDD.

However, there has been no discussion on communication apparatuses and methods for optimising time domain window and DMRS for joint channel estimation in order to enhance coverage performance for both FR1 and FR2, as well as TDD and FDD.

There is thus a need for communication apparatuses and methods that provide feasible technical solutions for optimising time domain window and DMRS for joint channel estimation. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and methods for optimising time domain window and DMRS for joint channel estimation.

According to an embodiment of the present disclosure, there is provided a communication apparatus comprising: circuitry, which in operation, determines one or more time domain windows for multiple physical uplink shared channel (PUSCH) transmissions, each length of the one or more time domain windows being not more than an overall length of the multiple PUSCH transmissions; and a transmitter, which in operation, transmits reference signals based on the one or more time domain windows.

According to another embodiment of the present disclosure, there is provided a communication method comprising: determining one or more time domain windows for multiple PUSCH transmissions, each length of the one or more time domain windows being not more than an overall length of the multiple PUSCH transmissions; and transmitting reference signals based on the one or more time domain windows.

According to another embodiment of the present disclosure, there is provided a communication method comprising: receiving an indication of one or more time domain windows for multiple physical uplink shared channel (PUSCH) transmissions, each length of the one or more time domain windows being not more than an overall length of the multiple PUSCH transmissions; and circuitry, which in operation, transmits reference signals based on the one or more time domain windows.

According to another embodiment of the present disclosure, there is provided a base station comprising: circuitry, which in operation, circuitry, which in operation, determines one or more time domain windows for multiple physical uplink shared channel (PUSCH) transmissions, each length of the one or more time domain windows being not more than an overall length of the multiple PUSCH transmissions; and a transmitter, which in operation, indicates the one or more time domain windows to one or more communication apparatuses.

According to another embodiment of the present disclosure, there is provided a communication method comprising: determining one or more time domain windows for multiple physical uplink shared channel (PUSCH) transmissions, each length of the one or more time domain windows being not more than an overall length of the multiple PUSCH transmissions; and indicating the one or more time domain windows to one or more communication apparatuses

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary 3GPP NR-RAN architecture.

FIG. 2 depicts a schematic drawing which shows functional split between NG-RAN and 5GC.

FIG. 3 depicts a sequence diagram for RRC (radio resource control) connection setup/reconfiguration procedures.

FIG. 4 depicts a schematic drawing showing usage scenarios of Enhanced mobile broadband (eMBB), Massive Machine Type Communications (mMTC) and Ultra Reliable and Low Latency Communications (URLLC).

FIG. 5 shows a block diagram showing an exemplary 5G system architecture for V2X communication in a non-roaming scenario.

FIG. 6 shows an illustration of a set of 3 combinations of multiple Physical Uplink Shared Channel (PUSCH) transmissions and the length of time domain window according to various embodiments.

FIG. 7 shows an illustration of a time domain window repetition according to various embodiments.

FIG. 8 shows an illustration of an enhanced PDSCH-TimeDomainResourceAllocation information element (IE) according to an example.

FIG. 9 shows an enhanced time domain resource allocation (TDRA) table according to an example.

FIG. 10 shows an illustration of time domain windows according to various embodiments.

FIG. 11 shows an illustration of an enhanced PDSCH-TimeDomainResourceAllocation IE according to another example.

FIG. 12 shows an enhanced TDRA table according to another example.

FIG. 13 shows an illustration of how DMRS symbols may be allocated in time domain windows according to an example.

FIG. 14 shows an enhanced preconfigured TDRA table according to an example.

FIG. 15 shows an illustration of how DMRS symbols may be allocated in time domain windows according to another example.

FIG. 16 shows an illustration of time domain windows with multiple hops from different frequency allocations according to an example.

FIG. 17 shows an illustration of time domain windows with integration of joint channel estimation (CE) and inter-slot frequency hopping (FH) according to an example.

FIG. 18 shows a modified Table 7.3.1.1.1-3 of TS 38.212 for integration of joint CE and inter-slot FH according to an example.

FIG. 19 shows an illustration of time domain windows with integration of joint CE and inter-slot FH according to another example.

FIG. 20 shows an illustration of time domain windows with integration of joint CE and intra-slot FH according to an example.

FIGS. 21A and 21B shows flow diagrams illustrating communication methods according to various embodiments.

FIG. 22 shows a schematic example of a communication apparatus in accordance with various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

3GPP has been working at the next release for the 5^{th} generation cellular technology, simply called 5G, including the development of a new radio (NR) access technology operating in frequencies ranging up to 100 GHz. The first version of the 5G standard (Rel. 15) was completed at the end of 2017, which allows proceeding to 5G NR standard-compliant trials and commercial deployments of smartphones. A recent version (Rel. 16) was released in June 2020, which brings IMT-2020 submission for an initial full 3GPP 5G system to its completion and enabling more advanced features for cellular communications.

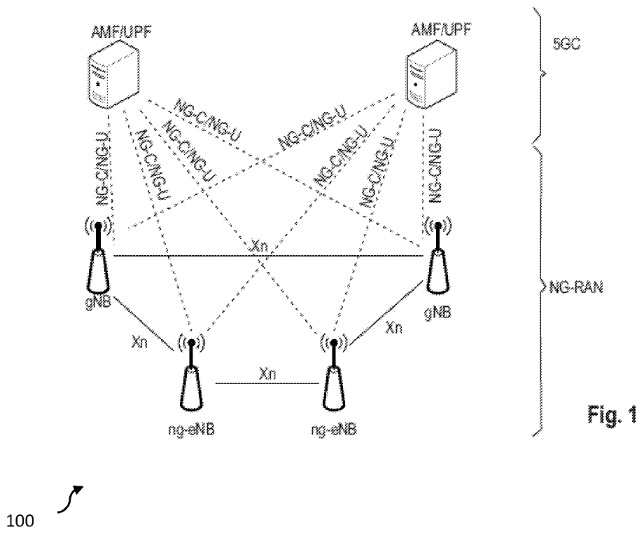

Among other things, the overall system architecture assumes an NG-RAN (Next Generation-Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v16.3.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300. Further, sidelink communications is introduced in 3GPP TS 38.300 v16.3.0. Sidelink supports UE-to-UE direct communication using the sidelink resource allocation modes, physical-layer signals/channels, and physical layer procedures (see for instance section 5.7 of TS 38.300).

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH, PUSCH and PUCCH for uplink and PDSCH (Physical Downlink Shared Channel), PDCCH and PBCH (Physical Broadcast Channel) for downlink. Further, physical sidelink channels include Physical Sidelink Control Channel (PSCCH), Physical Sidelink Shared Channel (PSSCH), Physical Sidelink Feedback Channel (PSFCH) and Physical Sidelink Broadcast Channel (PSBCH).

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than a mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v16.3.0).

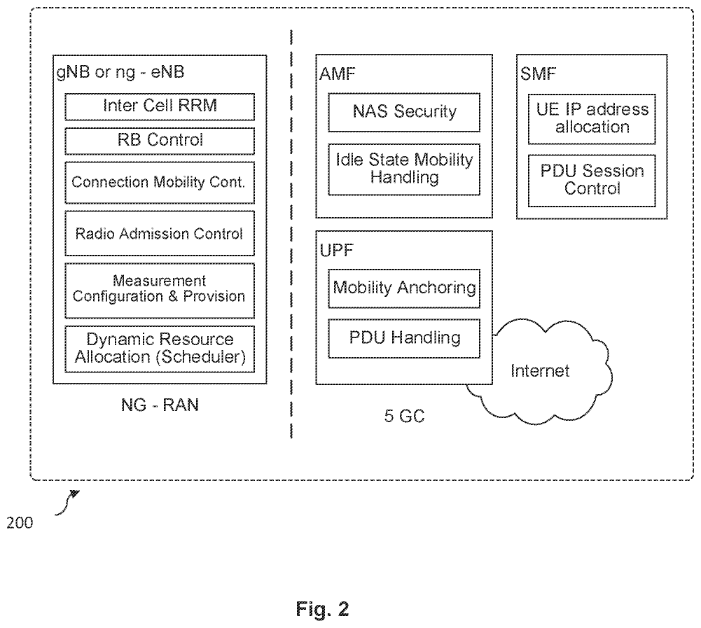

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.

The Access and Mobility Management Function (AMF) hosts the following main functions:
Non-Access Stratum, NAS, signaling termination;
NAS signaling security;
Access Stratum, AS, Security control;
Inter Core Network, CN, node signaling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.

Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.

Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

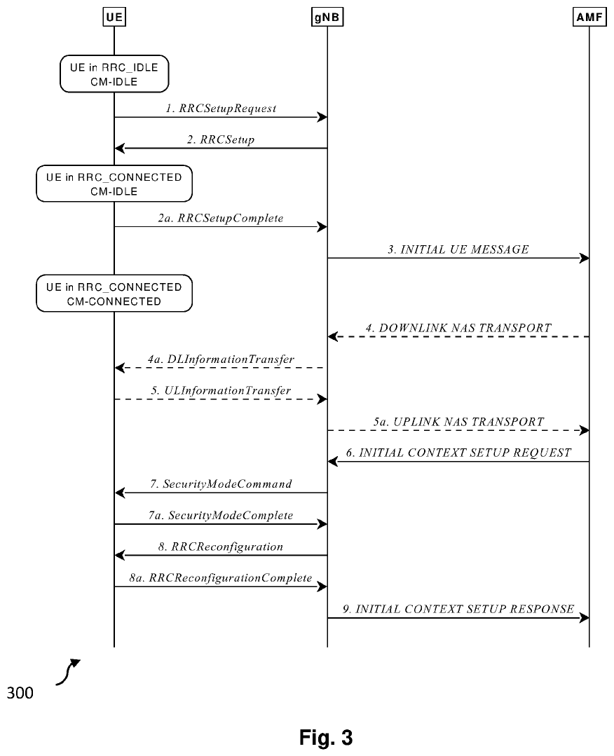

FIG. 3 illustrates some interactions between a UE, gNB, and AMF (an 5GC entity) in the context of a transition of the UE from RRC_IDLE to RRC_CONNECTED for the NAS part (see TS 38.300 v16.3.0). The transition steps are as follows:
1. The UE requests to setup a new connection from RRC_IDLE.
2/2a. The gNB completes the RRC setup procedure.
NOTE: The scenario where the gNB rejects the request is described below.
3. The first NAS message from the UE, piggybacked in RRCSetupComplete, is sent to AMF.
4/4a/5/5a. Additional NAS messages may be exchanged between UE and AMF, see TS 23.502 reference [22] (3GPP TS 23.122: “Non-Access-Stratum (NAS) functions related to Mobile Station in idle mode”).
6. The AMF prepares the UE context data (including PDU session context, the Security Key, UE Radio Capability and UE Security Capabilities, etc.) and sends it to the gNB.
7/7a. The gNB activates the AS security with the UE.
8/8a. The gNB performs the reconfiguration to setup SRB2 and DRBs.
9. The gNB informs the AMF that the setup procedure is completed.

RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signaling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

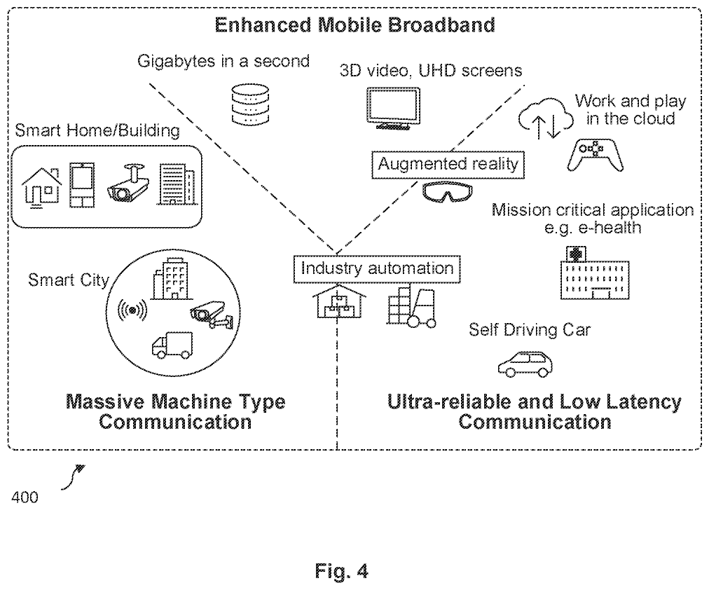

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1 E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented Reality/Virtual Reality (AR/VR), e-health, e-safety, and mission-critical applications.

Moreover, technology enhancements targeted by NR URLLC aim at latency improvement and reliability improvement. Technology enhancements for latency improvement include configurable numerology, mini-slot-based scheduling with flexible mapping, grant free (configured grant) uplink, mini-slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1 E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few μs where the value can be one or a few μs depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

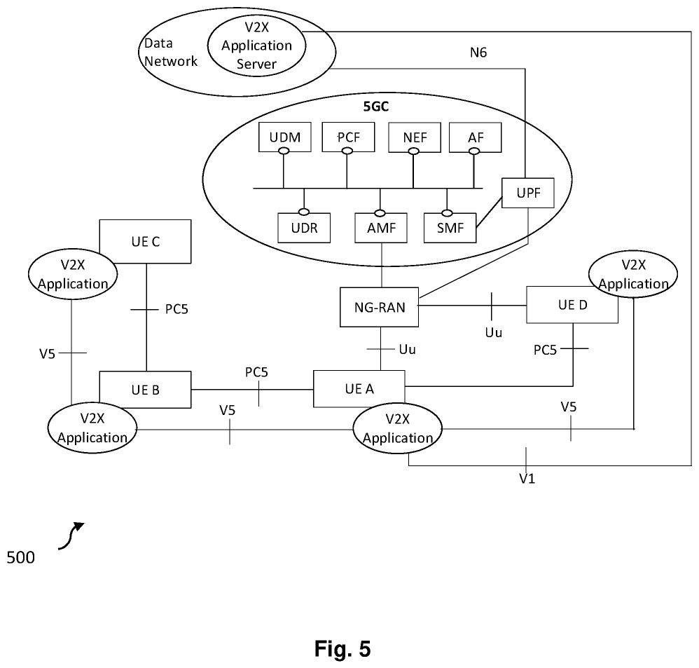

FIG. 5 illustrates a 5G NR non-roaming reference architecture (see TS 23.287 v16.4.0, section 4.2.1.1). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture for V2X communication, namely, Unified Data Management (UDM), Policy Control Function (PCF), Network Exposure Function (NEF), Application Function (AF), Unified Data Repository (UDR), Access and Mobility Management Function (AMF), Session Management Function (SMF), and User Plane Function (UPF) in the 5GC, as well as with V2X Application Server (V2AS) and Data Network (DN), e.g. operator services, Internet access or 3rd party services. All of or a part of the core network functions and the application services may be deployed and running on cloud computing environments.

In the present disclosure, an application server (for example, V2X Application Server in FIG. 5) may be provided to handle QoS requirements for V2X communications as per defined in Section 5.4 of TS23.287.

Power saving for UEs has been discussed in rel.17 V2X WID (RP-202846). Power saving enables UEs with battery constraint to perform sidelink operations in a power efficient manner. Rel-16 NR sidelink is designed based on the assumption of “always-on” when UE operates sidelink, e.g., only focusing on UEs installed in vehicles with sufficient battery capacity. Solutions for power saving in Rel-17 are required for vulnerable road users (VRUs) in V2X use cases and for UEs in public safety and commercial use cases where power consumption in the UEs needs to be minimized.

According to ETSI TR 103 300-1, the following types of road users are considered as vulnerable road users.
Pedestrians (including children, elderly, joggers).
Emergency responders, safety workers, road workers.
Animals such as horses, dogs down to relevant wild animals (see note below).
Wheelchairs users, prams.
Skaters, Skateboards, Segway, potentially equipped with an electric engine.
Bikes and e-bikes with speed limited to 25 km/h (e-bikes, class L1e-A [i.8]).
High speed e-bikes speed higher than 25 km/h, class L1e-B [i.8].
Powered Two Wheelers (PTW), mopeds (scooters), class L1e [i.8].
PTW, motorcycles, class L3e [i.8];
PTW, tricycles, class L2e, L4e and L5e [i.8] limited to 45 km/h;
PTW, quadricycles, class L5e and L6e [i.8] limited to 45 km/h.
NOTE: Relevant wild animals are only those which present a safety risk to other road users (VRUs, vehicles)
   The classification in Annex 1 of Regulation (EU) 168/2013 [i.8] may also be considered.

One of the main objectives for Rel-17 WI on NR coverage enhancements (CovEnh) is to enable joint channel estimation (CE). The following potential use cases are considered for joint channel estimation for PUSCH:
Use case 1: back-to-back PUSCH transmissions within one slot.
Use case 2: non-back-to-back PUSCH transmissions within one slot with the maximum gap of x-symbols between two adjacent PUSCH transmissions.
Use case 3: back-to-back PUSCH transmissions across consecutive slots.
Use case 4: non-back-to-back PUSCH transmissions across consecutive slots with the maximum gap of y-symbols between two adjacent PUSCH transmissions.
Use case 5: PUSCH transmissions across non-consecutive slots with the maximum gap of z-slots between two adjacent PUSCH transmissions.

These potential use cases can be applied for PUSCH transmissions of repetition type A/B of a single transport block (TB), PUSCH transmissions of a TB processing over multiple slots, or PUSCH transmissions of multi-transport block scheduling by a single DCI over multiple slots. These PUSCH transmissions can be scheduled by either dynamic grant or configured grant.

A UE might perform certain periodic or aperiodic events, such as frequency tracking, calibration, or other actions at a slot boundary such that it can impact phase continuity. Due to a change of pathloss measurements, a transmit power control of PUSCH at a UE side can be changed accordingly. An associated gNB might or might not be aware of some changes in such events. However, in order to guarantee performance of CE by using jointly DMRS symbols among PUSCH transmissions, a UE needs to maintain power consistency and phase continuity over a duration of time for these PUSCH transmissions. Furthermore, how to enable joint CE, as well as how to integrate joint CE and frequency hopping procedures, are not defined yet.

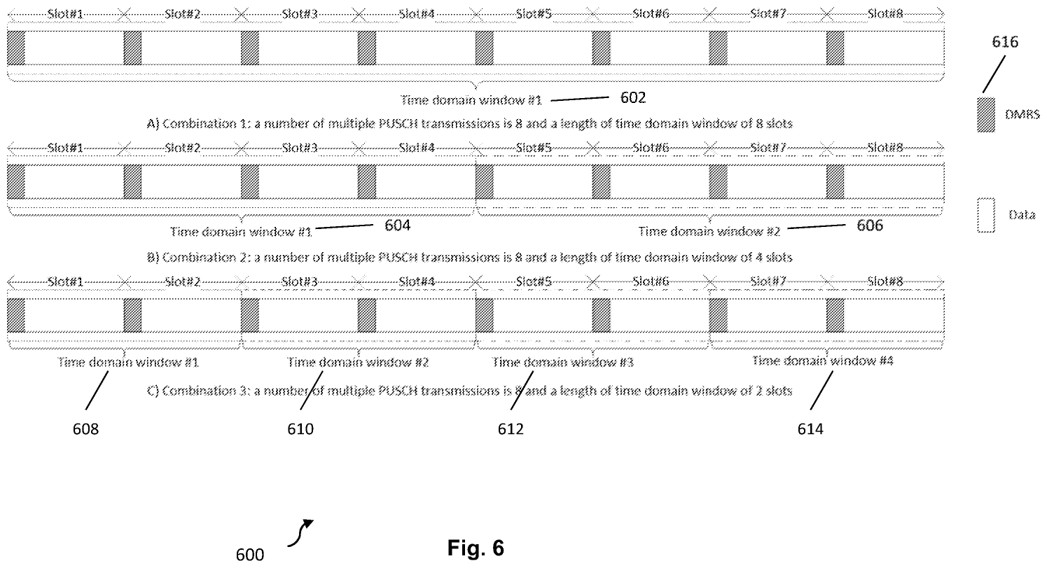

As a solution for enabling joint CE, a length of time domain window for enabling joint CE may be adjusted in multiple PUSCH transmissions configured by gNB. The length of time domain window may be equal to or smaller than the overall length of the multiple PUSCH transmissions. DMRS symbols are only bundled within the length of time domain window for joint CE. For example, referring to FIG. 6, time domain window 602 has a length equal to the overall length of the multiple PUSCH transmissions (i.e. 8 slots), each of time domain windows 604 and 606 has a length equal to half the overall length of the multiple PUSCH transmissions (i.e. 4 slots each), and each of time domain windows 608, 610, 612 and 614 has a length equal to a quarter of the overall length of the multiple PUSCH transmissions (i.e. 2 slots each). DMRS symbols 616 are only bundled within the length of these time domain windows for joint CE.

Furthermore, transmission of the DMRS symbols 616 (or reference signals) can be adjusted as well. Referring to time domain windows 608, 610, 612 and 614 for example, a first set of reference signals may be generated and transmitted in a first time domain window 608 of the one or more time domain windows 608, 610, 612 and 614, and a second set of reference signals may be generated and transmitted in a second time domain window 610 of the one or more time domain windows 608, 610, 612 and 614, such that the first set of reference signals can be different from the second set of reference signals.

Phase continuity and power consistency are two basic conditions for joint CE. For example, joint CE can be done when, in terms of phase continuity, the phase error is less than around a few degrees or frequency error is about +/−0.1 ppm. Additional conditions may include:
Modulation order does not change.
RB allocation in terms of length and frequency position should not be changed, and intra-slot and inter-slot frequency hopping is not enabled within a repetition bundle.
No change on transmission power level of its own component carrier (CC), i.e., no change on the power control parameters specified in TS 38.213, and also when own CC is not impacted by other concurrent CC(s) that are configured for inter-band carrier aggregation (CA) or dual-connectivity (DC) for same UE with dynamic power sharing and no change in any configured CCs that are part of configured intra-band uplink CA or DC.
No UL beam switching for FR2 UE occurs.

In addition, for non-back-to-back (or non-consecutive) transmission with non-zero gap in-between adjacent transmissions, at least following additional condition also need to be met in addition to the above conditions.
No downlink reception in-between the PUSCH or PUCCH repetition in the same band for TDD case.
For a scenario of no more than Z un-scheduled OFDM symbols in-between the PUSCH or PUCCH repetition (e.g., Z=0, 1, 2, . . . , 14), and a scenario of other physical signals/channels in-between PUCCH or PUSCH repetitions from the UE perspective, e.g., SRS or PUCCH transmission in-between the PUSCH repetition from the other UEs, the value of Z is small depending on UE capability or channel condition such that UE can maintain phase continuity.
   It will be appreciated that ‘back-to-back’ and ‘consecutive’ may be used interchangeably.

In a first option, the UE determines the length of time domain window length based on the indication from gNB. In a second option, the UE determines the length of time domain window and indicates it to gNB. For both options, performance of coverage is advantageously improved by using joint channel estimation.

In an embodiment 1, a UE determines the length of time domain window length based on an indication from gNB. The length of time domain window is configured from a limited set of combinations of the number of multiple PUSCH transmissions and the length of time domain window (i.e., configured from a subset of candidate lengths that is smaller than a set comprising all possible lengths that a time domain window can have). For example, the length of time domain window may be limited to 2, 4, 8 for 8 multiple PUSCH transmissions while all possible lengths are 1, 2, 3, 4, 5, 6, 7 and 8, as shown in FIG. 6. Alternatively, the length of time domain window may be limited to 2, 3, 4, 5, 6, 7 and 8 for 8 multiple PUSCH transmissions, i.e., a subset of lengths 2, 3, 4, 5, 6, 7 and 8 while all possible lengths are 1, 2, 3, 4, 5, 6, 7 and 8. The time domain window can be defined/configured by using at least one of variations 1.1-1.4 that will be presented below. Further, a TDRA table can be used to indicate the length of time domain by using at least one of variations 1.5-1.9 that will also be presented below.

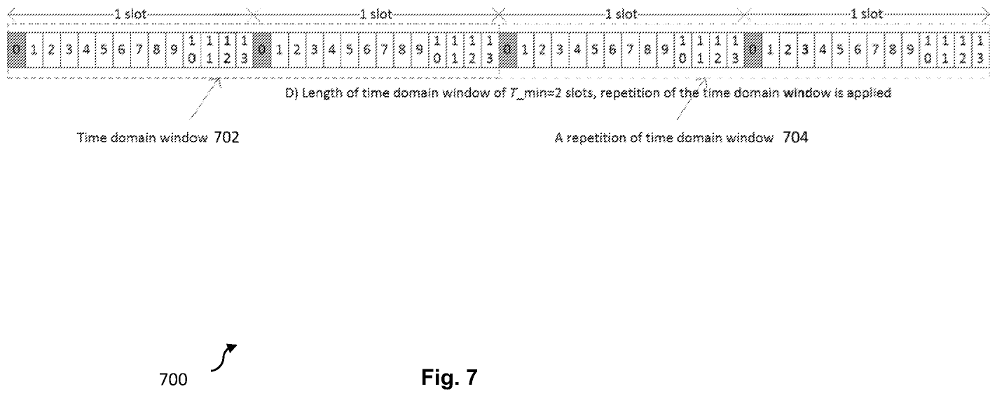

In a variation 1.1, the minimum length of time domain window of Tₘᵢₙ is derived from a set of values reported from all types of UEs (capabilities) and/or use cases. Tₘᵢₙ is configured to be repeated continuously up to a UE's capability. For example, referring to FIG. 7, a time domain window 702 with length of Tₘᵢₙ=2 slots is used, and it is repeated one time as time domain window 704 due to UE capability.

In a variation 1.2, an offset period between the indication from gNB and the beginning of the length of time domain window for DMRS bundling is P₂ symbol(s) or slot(s). P₂ can be equal to or different from K₂ which indicates the slot where a UE shall transmit the first PUSCH of the multiple PUSCH transmissions.

In a variation 1.3, the length of a time domain window is different based on a number of multiple PUSCH transmissions. For example, the length of a time domain window may be selected from 2, 3, 4, 5, 6, 7, 8 for 8 multiple PUSCH transmissions, or selected from 1, 2, 3, 4 for 4 multiple PUSCH transmissions. For another example, assuming a total of 8 PUSCH transmissions in 8 consecutive slots, the first length of the first window of the one or more time domain windows includes 2 PUSCH transmissions in 2 consecutive slots, while the first length of the second window of the one or more time domain windows includes 6 PUSCH transmissions in 6 consecutive slots.

In a variation 1.4, the length of a time domain window is selected from a plurality of values (i.e., selected from a subset having a plurality of candidate lengths or values), each of the plurality of values being different based on a number of multiple PUSCH transmissions. For example, the length of a time domain window is selected from 2, 3, 4, 5, 6, 7, 8 for 8 multiple PUSCH transmissions, and the length of time domain window is selected from 1, 2, 3, 4 for 4 multiple PUSCH transmissions.

Alternatively, the length of a time domain window is selected from a same number of candidates (e.g., 4 candidates). For example, the length of a time domain window is selected from 2, 4, 6, and 8 for 8 multiple PUSCH transmissions, and the length of time domain window is selected from 1, 2, 3, 4 for 4 multiple PUSCH transmissions. Further, each length included in the subset may be a multiple of one length included in the subset. For example, 2, 4, 6, and 8 are a multiple of 2 included in the subset.

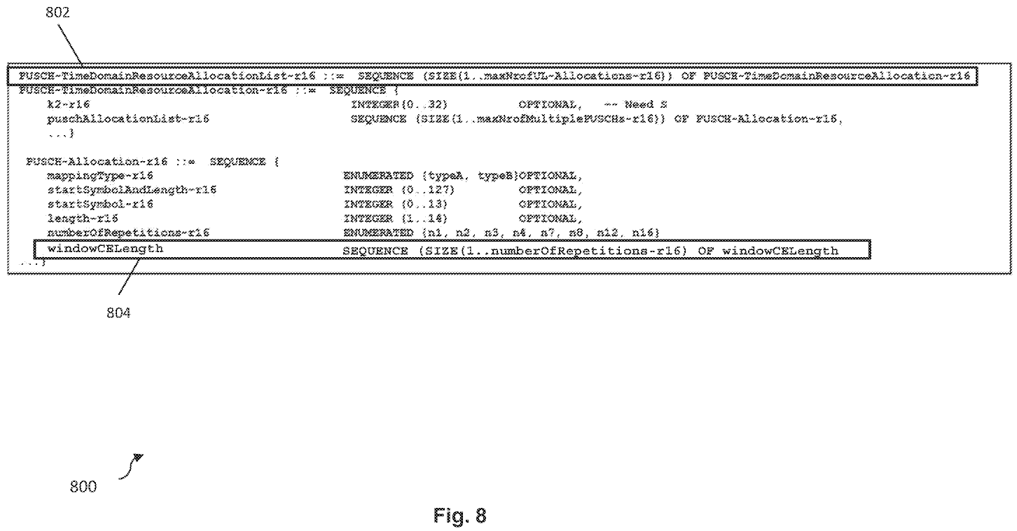

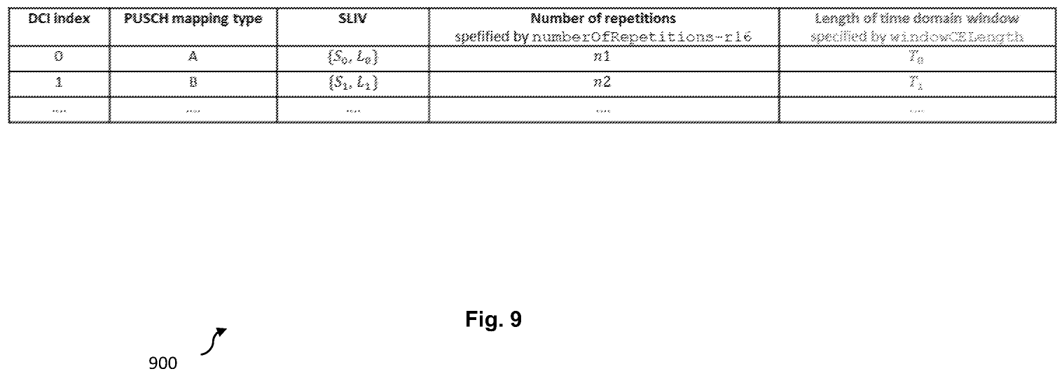

In a variation 1.5, an enhanced TDRA table is configured by RRC to facilitate joint channel estimation. For example, referring to an enhanced PDSCH-TimeDomainResourceAllocation information element (IE) 800 of FIG. 8, windowCELength 804 is added to enhance PUSCH-TimeDomainResourceAllocation IE 800 to configure a length of time domain window as Ti. PUSCH-TimeDomainResourceAllocationList 802 contains one or more of such PUSCH-TimeDomainResourceAllocations. A bit-field TDRA in a DCI index is used to indicate one of the indexes of the enhanced TDRA table 900 as shown in FIG. 9. For example, the length of time domain window (specified by windowCELength 804 in IE 800) is T_{O} when the DCI index is 0, and Tᵢ when the DCI index is 1. It will be appreciated that other possible TDRA tables can also be applied.

In a variation 1.6, in the enhanced TDRA table 900, which length(s) of time domain windows for joint CE to activate or deactivate are configured by the bitmap in medium access control (MAC) control element (MAC CE), wherein the activated length can be indicated in MAC CE by the same bit-field of TDRA or other fields. In a variation 1.7, in the enhanced TDRA table 900, other parameters for joint CE can also be included such as a type of UE that supports joint CE (e.g., reduced capability (RedCap) UEs, eMBB UEs, or URLLC UEs, etc), requirement range of phase continuity, etc. In a variation 1.8, for a UL grant scheduled in a DCI and a configured grant (CG) type 2 activated by a DCI, the length of time domain window may be indicated in the scheduled/activated DCI by using the same bit-field of TDRA or other fields. In a variation 1.9, for CG type 1, the length of time domain window is indicated semi-statically by RRC.

In an embodiment 1.1, a trade-off between performance of joint CE and achievable gains is proposed to reduce/omit DMRS symbol(s) of the multiple PUSCH transmissions within the length of time domain window.

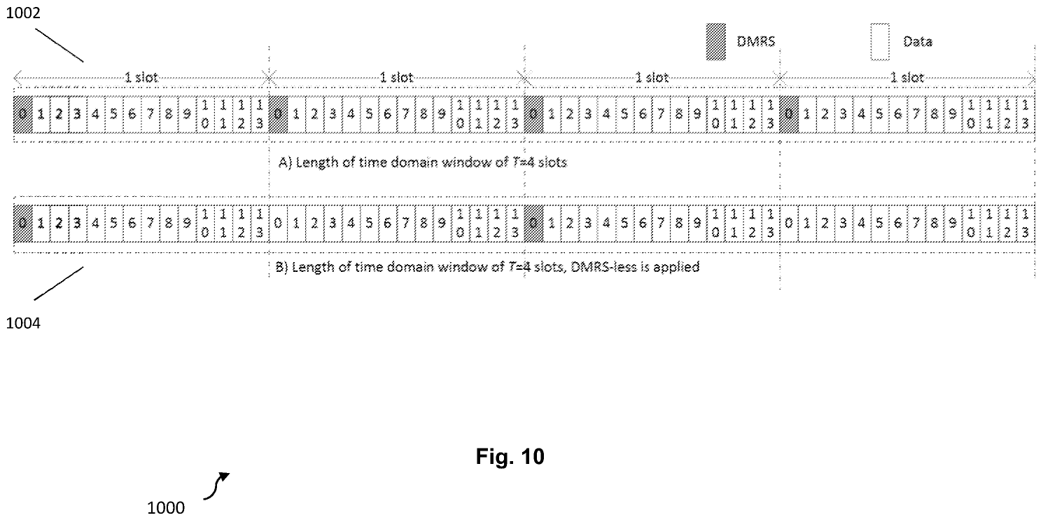

Referring to FIG. 10, an example time domain window for embodiment 1 is presented as time domain window 1002 with a length of T=4 slots, where each slot in the time domain window 1002 has a DMRS symbol 1004. An example time domain window for embodiment 1.1 is presented as time domain window 1006 with a length of T=4 slots but with DMRS-less being applied, such that a smaller number of DMRS symbols 1004 are transmitted within the length of time domain window 1006. DMRS-less means a smaller number of DMRS (i.e., including a case of non-DMRS configuration) than that of using current configuration of DMRS specified in Rel. 15/16 is applied. DMRS-less is applied by considering a trade-off performance of joint CE and some gains due to reducing DMRS. Advantageously, some achievable gains (coding gain, reduction of system overhead) can be obtained by reducing the number of DMRSs. The ratio of a smaller number of DMRS symbols may be different based on a number of the multiple PUSCH transmissions. For another example, if the length of time domain window includes both special and uplink (UL) slots for the multiple PUSCH transmissions, DMRS symbol(s) in the special slot are reduced/omitted due to the small number of available UL symbols. Furthermore, for repetitions of the multiple PUSCH transmissions for transport block(s), DMRS symbol(s) in one or more of the repetitions are reduced/omitted, herein for an example, DMRS(s) in some PUSCH repetition type A transmissions can be omitted. The UE thus transmits a smaller number of DMRSs, where their locations are (pre-)configured.

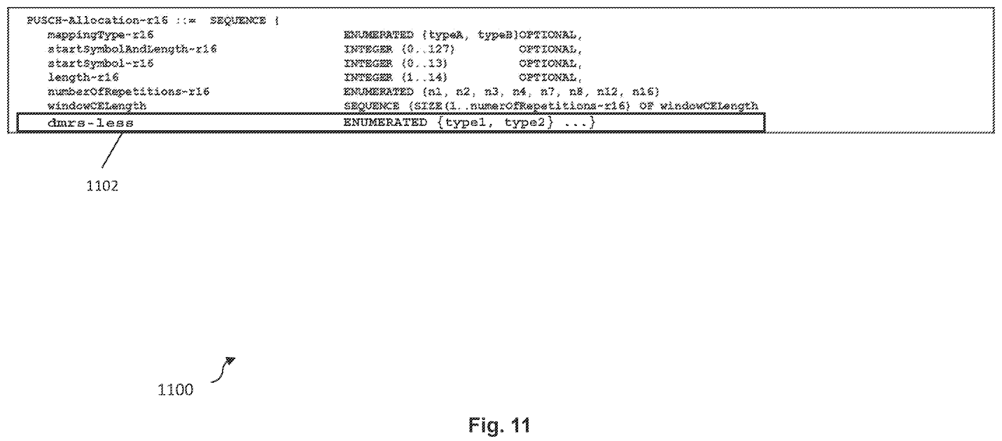

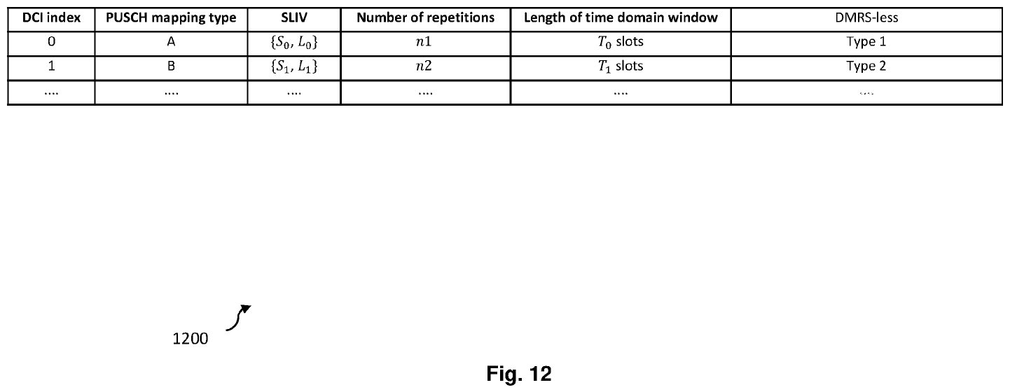

Referring to FIG. 11 and FIG. 12, a smaller number of DMRSs (i.e., DMRS-less as explained above) can be additionally configured in PUSCH-TimeDomainResourceAllocation IE 1100 (i.e. RRC signalling, via drms-less portion 1102) and enhanced TDRA table 1200 as Type 1 or Type 2. For example, DMRS(s) are only located in either one of the even slot(s) and the odd slot(s) within the length of time domain window. Alternatively, For Type 1, DMRS(s) may be only located in the even slot(s) within the length of time domain window. For Type 2, DMRS(s) may be only located in the odd slot(s) within the length of time domain window. It will be appreciated that other variations of Type 1 and Type 2 are also possible.

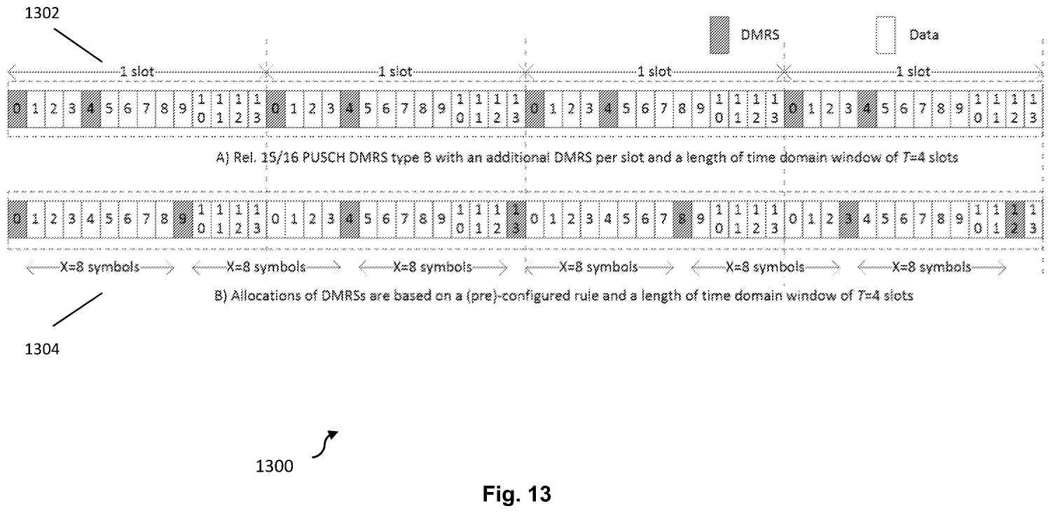

In an embodiment 1.2, an optimal allocation of DMRS symbols in the length of a time domain window is used for improving performance of joint CE. The optimal allocation of DMRS symbols is signalled implicitly or explicitly based on channel condition, so that performance of joint CE can be advantageously improved. Referring to FIG. 13, Rel. 15/16 PUSCH DMRS type B with an additional DMRS per slot is used within a time domain window 1302 of T=4 slots for joint CE. It should be noted that the current DMRS pattern in Rel. 15/16 is configured per slot and it has been designed without considering performance for enabling joint CE. For an implicit manner of signalling for optimal allocation of DMRS symbols, in the length of time domain window 1304, there is a (pre-)configured rule that the 1^{st} DMRS symbol is allocated by using Rel. 15/16 Specs, while the remaining DMRS symbols are allocated in places that an interval gap between two consecutive DMRSs is X symbol(s). For example, X=8 symbols is used in time domain window 1304. In other words, allocations of DMRSs in time domain window 1304 are based on a (pre)-configured rule, where the interval gap between 2 consecutive DMRS is X=8 symbols and a length of time domain window of T₀=4 slots for joint CE. It will be appreciated that other possible DMRS allocations can also be applied.

In an embodiment 2, a UE determines and indicates the length of time domain window to gNB. The length of time domain window is indicated in a UCI multiplexed with PUSCH transmission. The indication can point out one or more subsequent PUSCH transmissions in the length of time domain window are coherent with respect to (w.r.t) the PUSCH transmission that carries the UCI, wherein “coherent” as commonly used in the art means that the correlation between multiple PUSCH transmissions is small or is below a predefined threshold, i.e., channel is considered to be not varying in a coherent time. A benefit of this implementation is to achieve reasonable measurement effort and power consumption for a UE because the preferred/actual length of time domain window is based on its capability or channel condition/profiling.

In some circumstances, UE cannot maintain requirements of power consistency and phase continuity for enabling joint CE within the length of a time domain window, if the time domain window was to be configured by a gNB. It is possible that the time domain window is greater than a maximum duration that the UE is able to maintain power consistency and phase continuity subject to power consistency and phase continuity requirements. The maximum duration is subject to the UE capability. For example, the gNB might not be aware of changes in (periodic) events for the UE. Further, RAN1 has not agreed currently when a RedCap UE identification (or RedCap UE capability) is reported, i.e., RedCap UE identification can be reported by message 1 (Msg1), Msg3 PUSCH, or after Msg3 PUSCH. Assuming Msg3 PUSCH repetitions and joint CE are used, RedCap UE identification is reported after Msg3 PUSCH. A gNB may assume to configure a UE with a length of time domain window as a cell-specific value for joint CE for Msg3 PUSCH, e.g., T slots, but the UE can only maintain requirements of power consistency and phase continuity within a shorter/actual length of time domain window, e.g., M slots, where M≤T.

Thus, in an embodiment 2.1, a UE can indicate the actual length of time domain window of M slots to gNB, instead of T slots, in order to address the above issue. In an implementation, the UE transmits different DMRS densities for the actual length time domain window of M slots and the remaining (T-M) slots respectively. The UE transmits a smaller number of DMRSs than that indicated by gNB in one or more PUSCH transmissions in the length of time domain window of M slots, and the remaining DMRS(s) in the remaining (T-M) slots by using dmrs-AdditionalPosition in Rel. 15/16 Specs. A benefit of this implementation is to achieve gain due to reducing DMRS within M slots, while still capturing any change of channel condition in the remaining slots.

Furthermore, another understanding of the embodiment 2.1 is that, within the time domain window configured by gNB, the UE determines the actual length of time domain window based on one or more events which are transparent to gNB. The one or more events can include (i) where and when to cancel a PUSCH transmission based on Release 15/16/17 collision rules for PUSCH, (ii) DL slot or DL reception/monitoring based on semi-static DL/UL configuration for unpaired spectrum, (iii) other UL transmission in between PUSCH transmissions, (iv) indications for changing transmission parameters for PUSCH by gNB (such as UL beam switching, transmit power control command, timing advance command), (v) a maximum duration that a UE is able to maintain the requirements of power consistency and phase continuity (UE capability), (vi) frequency hopping, (vii) precoder cycling, etc. These events could be categorized as semi-static events or dynamic events, wherein an event is categorized as a dynamic event if it is triggered by a DCI or MAC-CE, otherwise it is categorized as a semi-static event. Since these events are transparent to gNB, it can determine the actual length of time domain window of the UE.

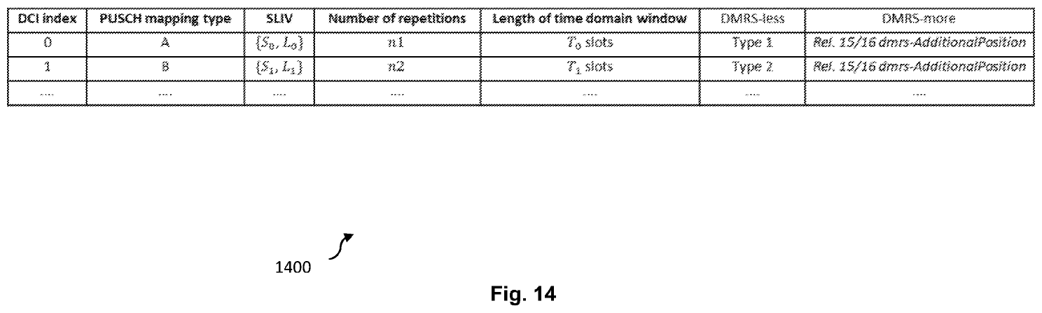

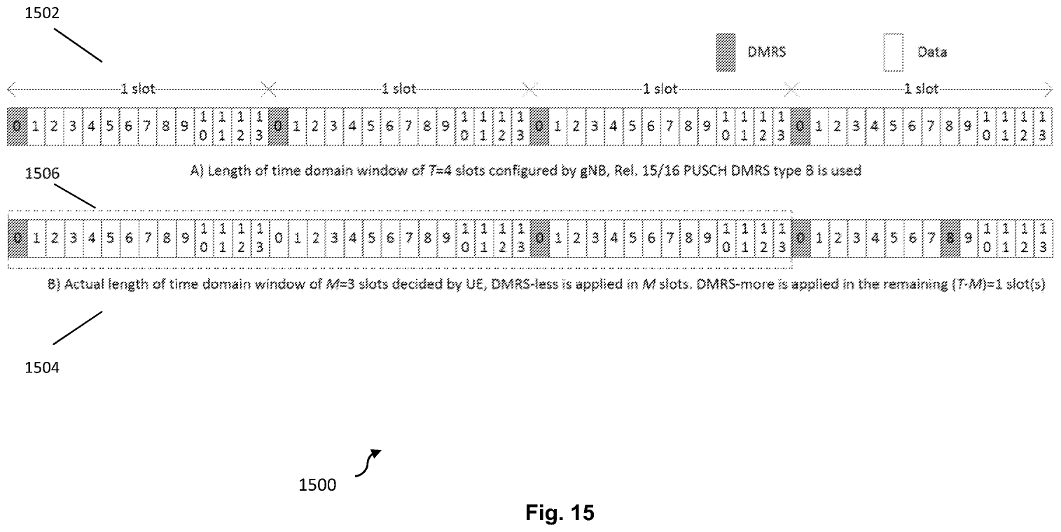

In an implementation of embodiment 2.1 referring to FIG. 14, DMRS-less/-more are included in enhanced TDRA table 1400, e.g., a preconfigured TDRA table in Specs, wherein DMRS-more means additional DMRS(s) are configured. An index of this table can be indicated by field(s) in a DCI over, for example, a Msg2 PDCCH. Referring to FIG. 15, for a time domain window 1502, gNB configures a length of T=4 slots and DMRS type B is used. For time domain window 1504 in accordance with embodiment 2.1, UE decides to maintain requirements for joint CE within M=3 slots i.e. at portion 1506. DMRS-less is used in M=3 slots, while DMRS-more is used in the remaining (T−M) portion=1 slot. It will be appreciated that different densities of DMRSs can also applied within and outside (the remaining portion) of the actual length of time domain window.

In another example for PUSCH transmissions in non-consecutive slots or symbols in a time division duplexing (TDD) configuration, assuming that multiple time domain windows are configured, a first set of reference signals may be generated and transmitted within each length of the multiple time domain windows, and a second set of reference signals may be generated and transmitted outside each length of the multiple time domain windows, such that the first set of reference signals can be different from the second set of reference signals. Specifically, assuming a DDSUUDDSUU format (i.e. D for downlink slot, S for special slot, U for uplink slot) is used for the transmission, a first time domain window may include UL symbol(s) in 1^{st} S slot and 1^{st} U slot, while a second time domain window may include UL symbol(s) in 3^{rd} and 4^{th} U slots. Density of DMRS or reference signals in the 2^{nd} U slot and 2^{nd} S slot can thus be different from the density of DMRS within the first and second time domain windows.

In a variation 2.2 of embodiment 2.1, if UE cannot maintain requirements of power consistency and phase continuity within T slots configured by gNB, current Rel.15/16 operations are used, i.e., joint CE over T slots is not used, but CE per slot is used. In a variation 2.3 for embodiments 2 and 2.1, an offset period between the indication and a first PUSCH transmission of the one or more subsequent PUSCH transmissions (or the length of time domain window) is P₀≥0 symbol(s) or slot(s).

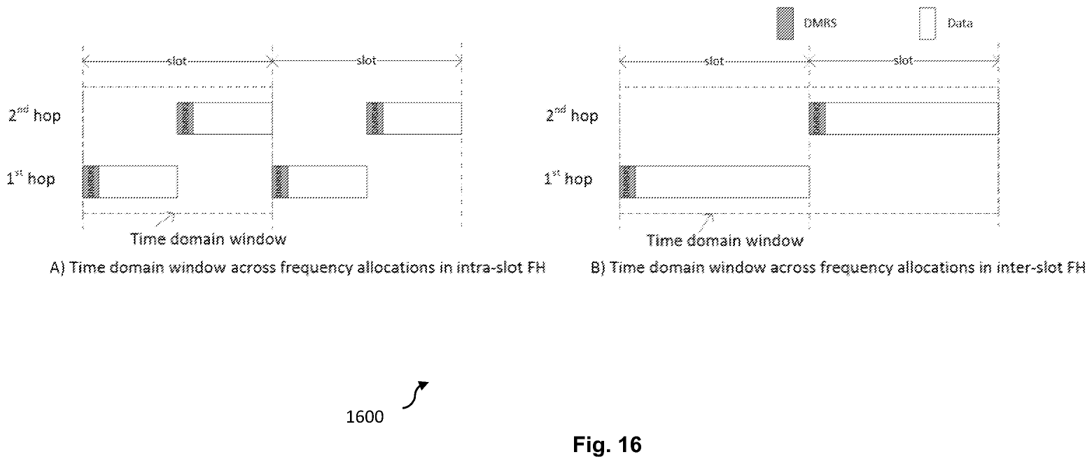

Generally in the various embodiments described in the present disclosure, if joint CE is simply applied in FH procedure, a length of time domain window can include multiple hops from different frequency allocations (upper and lower frequency positions) as shown in FIG. 16, resulting in degradation of performance of joint CE and FH. This is because jointly using DMRS #1 and DMRS #2 in the length of a time domain window for channel estimation can result in poor performance due to different phase continuities and channel conditions at different frequency hops. Following that, FH performance is poor.

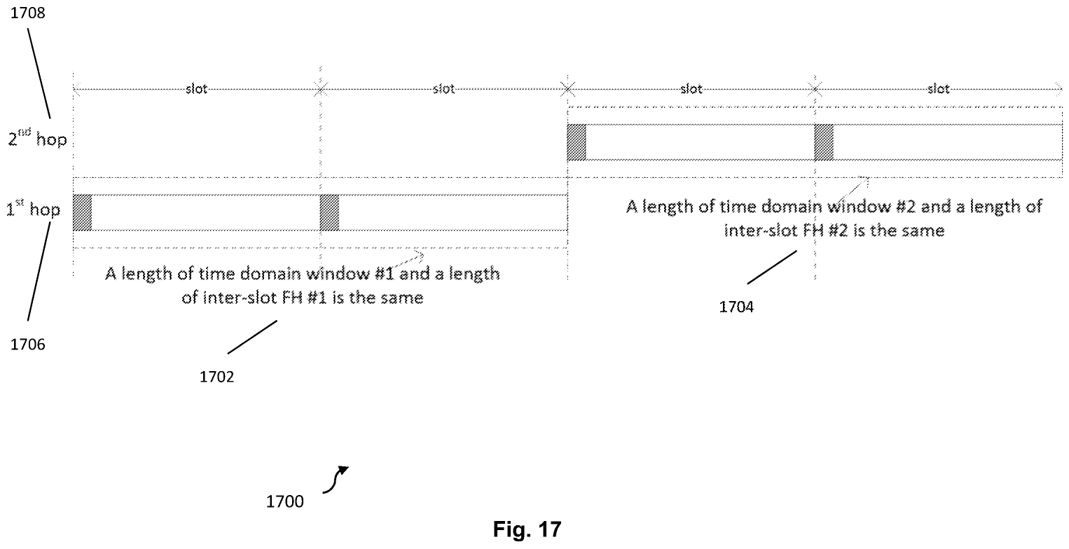

Thus, in an embodiment 3, an integration of joint CE and inter-slot FH procedures is proposed for a UE to address the above issue, wherein one or more lengths of time domain windows are configured to be jointly used with inter-slot FH. Referring to FIG. 17, each of the one or more lengths in time domain windows 1702 and 1704 is used for the same frequency allocation in inter-slot FH procedure. Each of the one or more lengths of time domain windows 1702 and 1704 and a length of inter-slot FH are the same. For example, time domain window 1702 has a length of 2 slots which is the same as the length of inter-slot FH 1706, while time domain window 1704 has a length of 2 slots which is the same as the length of inter-slot FH 1708. On the other words, inter-slot frequency hopping is applied for each of the one or more lengths of time domain windows. Within each of the one or more lengths of time domain windows, UE maintains the requirements of power consistency and phase continuity for joint CE. It can be implied for embodiment 3 that each of the one or more lengths of time domain windows is associated with a single DCI. Advantageously, performance is improved due to achieving some gains by using joint CE and FH procedures.

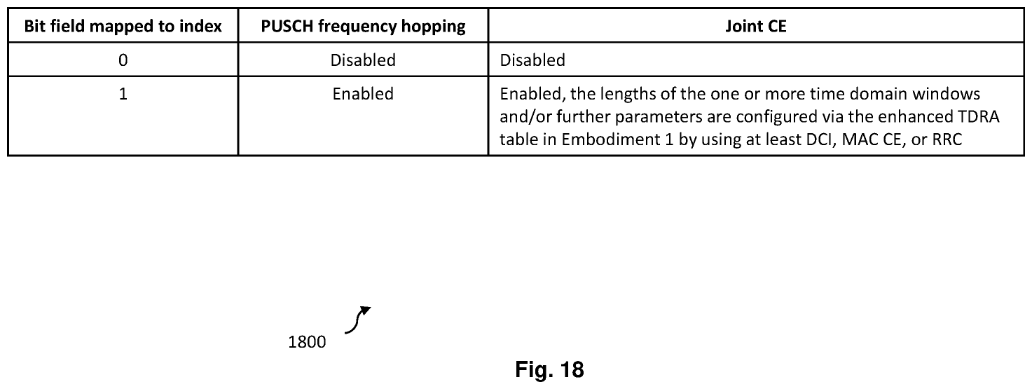

In an example implementation of embodiment 3, referring to FIG. 18, an existing indication of FH procedure in a DCI in Rel. 15/16 Specs is reinterpreted to enable/disable the integration of joint CE and inter-slot FH procedures by adding new entries (i.e., the one or more lengths of time domain windows and FH procedures are configured by using a single DCI). Any additional parameters are configured by using at least DCI, MAC CE, or RRC (via for example the enhanced TDRA table 900 as shown in FIG. 9 for Embodiment 1). For instance, 1 bit-field for FH procedure in a DCI is reinterpreted to enable an integration of joint CE and inter-slot FH procedure, i.e., an additional column in Table 7.3.1.1.1-3 of TS 38.212 is added to form Table 1800. For example, when a bit field mapped to index has a value of 0, inter-slot frequency hopping and joint CE are disabled. When the bit field value is 1, inter-slot frequency hopping and joint CE are enabled, such that the lengths of the one or more time domain windows and/or further parameters are configured via an enhanced TDRA table (i.e. enhanced TDRA table 900 of embodiment 1) by using at least DCI, MAC CE, or RRC. In FIG. 17, there are 02 inter-slot frequency hops 1706 and 1708, wherein each hop includes 2 consecutive slots. There are 02 time domain windows 1702 and 1704, where each of them includes 2 consecutive slots. Time domain windows 1702 and 1704 are used for inter-slot FH #1 1706 and FH #2 1708 respectively. In each time domain window, DMRSs are bundled for joint CE.

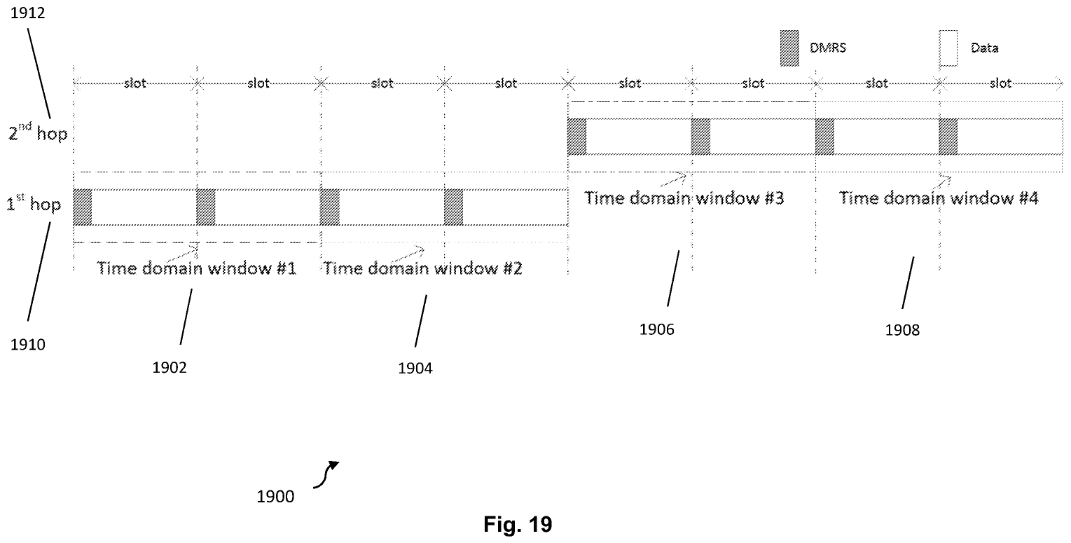

In a variation 3.1 of embodiment 3, each of the one or more lengths of time domain windows is different from a length of inter-slot FH. Referring to FIG. 19, there are 02 inter-slot frequency hops 1910 and 1912, where each hop includes 4 consecutive slots. There are 04 time domain windows 1902, 1904, 1906 and 1908, where each of them includes 2 consecutive slots. Time domain windows #1 1902 and #2 1904 are used for the 1st hop 1910, while time domain windows #3 1906 and #4 1908 are used for the 2nd hop 1912. In each time domain window, DMRSs are bundled for joint CE. Starting positions of each hop may be aligned to starting positions of any of the time domain windows. For example, starting positions of the 1st hop 1910 and 2^{nd} hop 1912 are aligned to starting positions of time domain windows #1 and #5. Further, a length of an inter-slot frequency hopping can be a multiple of each length of one or more time domain windows. For example in FIG. 19, the lengths of inter-slot FH 1910 and 1912 (i.e. 4 slots in length each) are multiples of each length of time domain windows 1902, 1904, 1906 and 1908 (i.e. 2 slots in length each). It will be appreciated that other variations in lengths of FHs and time domain windows are also possible.

In a variation 3.2 of embodiment 3, numerous combinations of precoding schemes, multiple frequency hops, and multiple length of time domain windows are applied. For example referring to FIG. 17, different precoding schemes for the 2 hops 1706 and 1708 can be applied in total 4 consecutive slots: precoding scheme A is used in the length of time domain window #1 1702 for the 1st hop 1704 at the lower frequency position, while precoding scheme B is used in the length of time domain window #2 1704 for the 2nd hop 1708 at the upper frequency position. In another example referring to FIG. 19, different precoding schemes can be applied for 2 hops 1910 and 1912 in total 8 consecutive slots: precoding scheme A is used in the length of time domain window #1 1902 for the 1st hop 1910 at the lower frequency position, precoding scheme B is used in the length of time domain window #2 1904 for the 1st hop 1910 at the lower frequency position, precoding scheme A is used in the length of time domain window #3 1906 for the 2nd hop 1912 at the upper frequency position, and precoding scheme B is used in the length of time domain window #4 1908 for the 2nd hop 1912 at the upper frequency position. It will be appreciated that other possible combinations of precoding schemes can also be applied.

In a variation 3.3 of embodiment 3 and variation 3.2, to achieve transmission (Tx) diversity gain of random precoding for a UE equipped with multiple antennas/panels, within a frequency hop, a proper value of the length of time domain window should be determined. For other precoding schemes, the relation among precoding vectors should be defined.

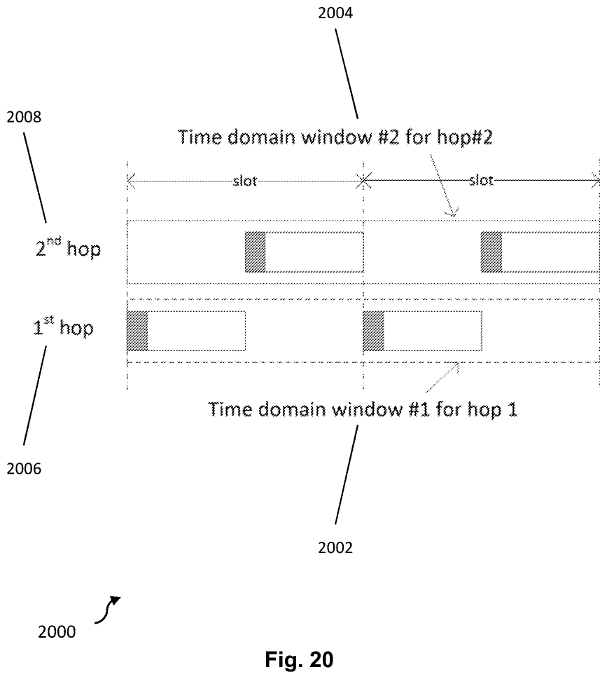

In a variation 3.4 of embodiment 3, instead of integrating with joint CE and inter-slot FH, integration with joint CE and intra-slot FH is applied. Each of the one or more lengths of time domain windows can be the same or different from a length of intra-slot FH. Reinterpreting an existing explicit indication or a new indication is used for this variation. For example, Integration of joint CE and intra-slot FH procedure is presented in FIG. 20, where a hop includes 2 consecutive time domain windows. Time domain window #1 2002 is used for the 1st hop 2006 at the lower frequency position, while time domain window #2 2004 is used for the 2nd hop 2008 at the upper frequency position. It will be appreciated that the DMRS-less implementation as shown in variation 1.8 can be similarly used for embodiment 3 and its variations for each of the one or more time domain windows.

According to network availability and capability of UEs, the multiple embodiments and their variations can be applied together in a same network. In embodiments 1-3, the length of time domain window can be a fixed window or a sliding window, i.e., the time domain window can be fixed or shifted in time domain with reference to an absolute timing. In embodiments 1-3, gNB can perform blind decoding of allocations of DMRSs within the length of time domain window.

When a UE is equipped with multiple antennas/panels, each of the multiple antennas/panels is assigned with each of the one or more lengths of time domain windows for PUSCH transmissions if the one or more length of time domain windows are configured. Each of the one or more lengths of time domain windows can be the same or different. For instance, a UE has 2 panels and 2 lengths of time domain windows are configured, where the 1st panel and 2nd panel are assigned with the 1st length and 2nd length of time domain windows respectively. Further, frequency hopping procedure and different precoding schemes can be used jointly.

Although the described issue and solutions are mainly used for PUSCH, it will be appreciated that they are also applicable for PUCCH, PDCCH, or PDSCH. In the described issues and solutions, the length of time domain window may be determined based on different criteria.

In embodiments 1-3, the length of time domain window for joint CE is not applied for different UL grants (dynamic and configured grant) at the same time in a configuration period. In the length of a time domain window, DMRS bundling for joint CE can be applied to satisfy requirements of at least power consistency and phase continuity across PUSCH transmissions. Further, DMRS bundling for joint CE is not applied for PUSCH transmissions scheduled outside the length of time domain window.

It would be appreciated that, in all embodiments, the joint channel estimation and the time domain window are jointly enabled and disabled to a UE. This is because a purpose of the time domain window is used for the joint channel estimation. In this manner, the enabling or disabling of joint channel estimation for PUSCH transmissions within a time domain window also means the enabling or disabling of DMRS bundling for PUSCH transmissions within the time domain window, respectively, under the conditions of power consistency and phase continuity. DMRS bundling means that gNB combines all DMRS symbols of PUSCH transmissions within the time domain window to perform a joint channel estimation in order to decode uplink data in these PUSCH transmissions.

The length of time domain window may include a set of consecutive symbols, slots, or repetitions for PUSCH transmissions. In the described issues and solutions, the length of time domain window also means a size of DMRS bundling, or the minimum length of a time domain window is equal to the number of back-to-back (or consecutive) PUSCH transmissions, or a duration of time that DMRS symbols in the one or more PUSCH transmissions are bundled for joint channel estimation.

Further in embodiment 1:
configuration of DMRSs specified in Rel. 15/16 is used in the length of time domain window;
the length of time domain window is derived based on the number of symbols, slots, or repetitions scheduled for multiple PUSCH transmissions;
the length of time domain window is a UE-specific value; and
the enhanced TDRA table is preconfigured in specification, e.g., Table 900 is a preconfigured table.

In embodiment 2.1, additional DMRS symbol(s) are configured explicitly by using a new configuration for additional DMRS(s); further, after a UE transmits DMRS in a long length time domain window, gNB may be able to segment it to some short time domain windows (and to bundle DMRSs in each of the short time domain windows). It will also be appreciated that additional DMRS(s) can be applied within length of time domain window.

In embodiment 3, instead of reinterpreting an existing explicit indication, a separate indication is used to point out the one or more lengths of time domain windows for joint CE.

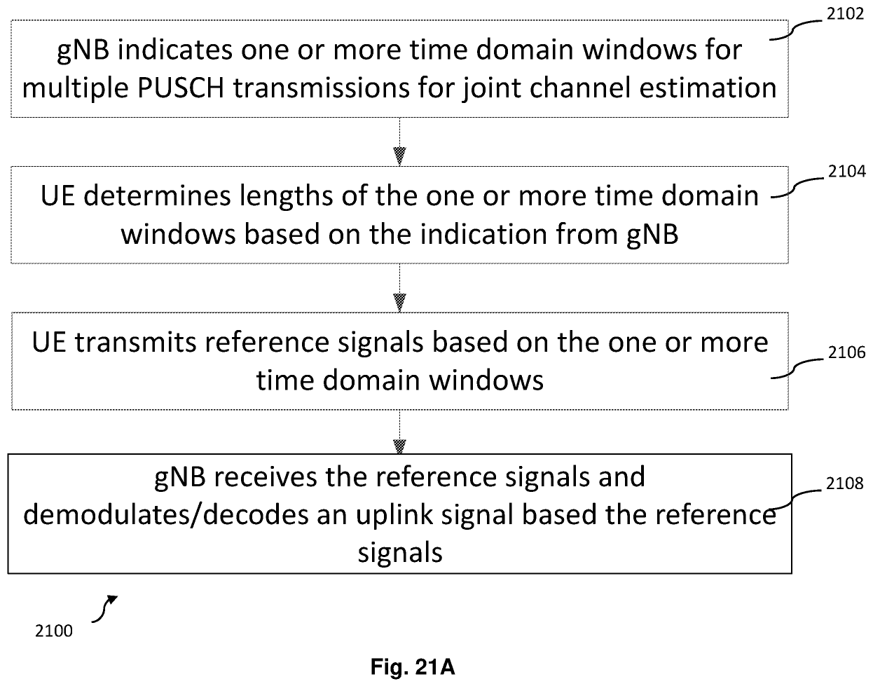

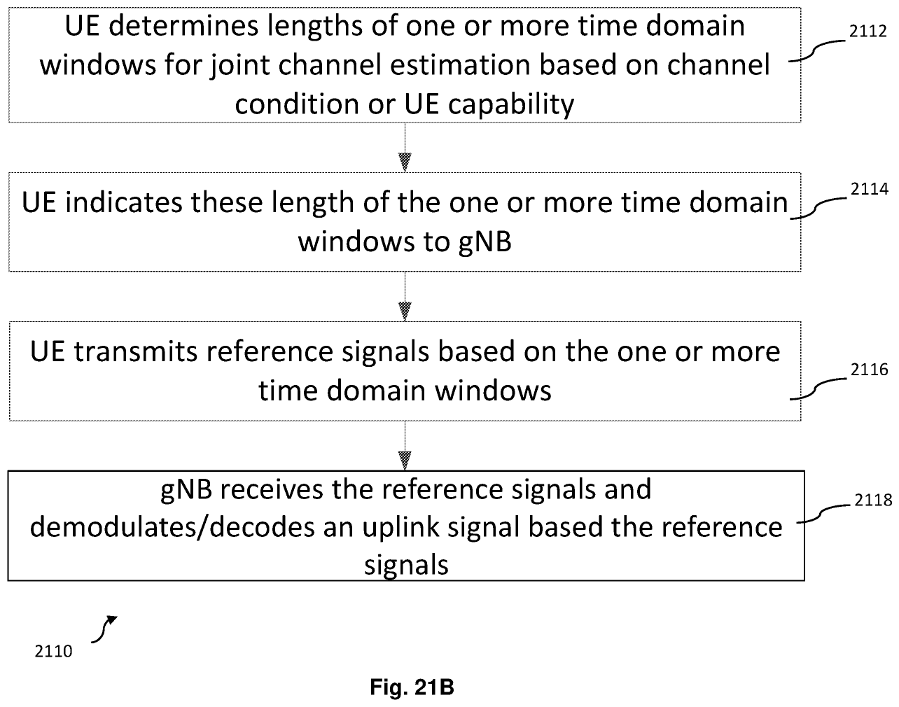

FIG. 21A shows a flow diagram 2100 illustrating a communication method according to various embodiments. In step 2102, a gNB indicates one or more time domain windows for multiple PUSCH transmissions for joint channel estimation. In step 2104, a UE determines lengths of the one or more time domain windows based on the indication from gNB. In step 2106, the UE transmits reference signals based on the one or more time domain windows. In step 2108, gNB receives the reference signals and demodulates/decodes an uplink signal (i.e. received from the UE) based the reference signals.

FIG. 21B shows a flow diagram 2110 illustrating a communication method according to various embodiments. In step 2112, a UE determines lengths of one or more time domain windows for joint channel estimation based on channel condition or UE capability. In step 2114, the UE indicates these lengths of the one or more time domain windows to a gNB. In step 2116, the UE transmits reference signals based on the one or more time domain windows. In step 2118, gNB receives the reference signals and demodulates/decodes an uplink signal (i.e. received from the UE) based the reference signals.

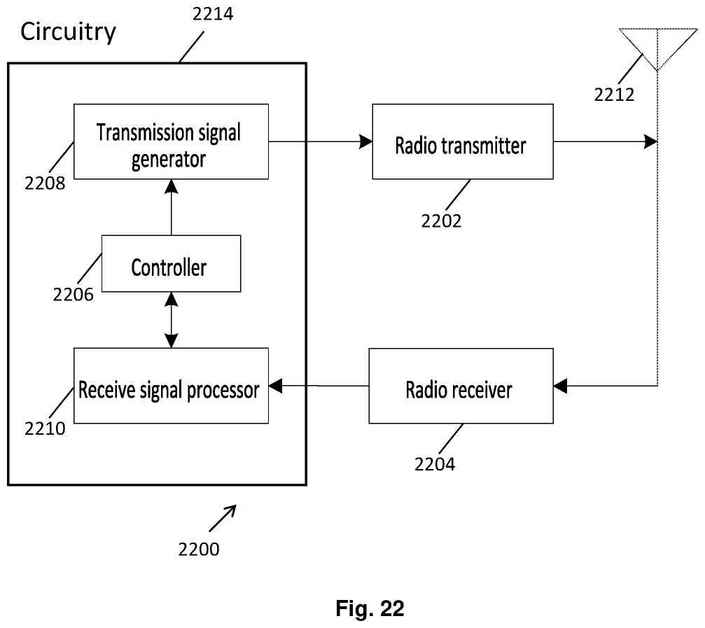

FIG. 22 shows a schematic, partially sectioned view of the communication apparatus 2200 that can be implemented for optimising time domain window and DMRS for joint channel estimation in accordance with various embodiments and examples as shown in FIGS. 1 to 21. The communication apparatus 2200 may be implemented as a UE or base station according to various embodiments.

Various functions and operations of the communication apparatus 2200 are arranged into layers in accordance with a hierarchical model. In the model, lower layers report to higher layers and receive instructions therefrom in accordance with 3GPP specifications. For the sake of simplicity, details of the hierarchical model are not discussed in the present disclosure.

As shown in FIG. 22, the communication apparatus 2200 may include circuitry 2214, at least one radio transmitter 2202, at least one radio receiver 2204, and at least one antenna 2212 (for the sake of simplicity, only one antenna is depicted in FIG. 22 for illustration purposes). The circuitry 2214 may include at least one controller 2206 for use in software and hardware aided execution of tasks that the at least one controller 2206 is designed to perform, including control of communications with one or more other communication apparatuses in a wireless network. The circuitry 2214 may furthermore include at least one transmission signal generator 2208 and at least one receive signal processor 2210. The at least one controller 2206 may control the at least one transmission signal generator 2208 for generating signals (for example, a signal indicating a geographical zone) to be sent through the at least one radio transmitter 2202 to one or more other communication apparatuses and the at least one receive signal processor 2210 for processing signals (for example, a signal indicating a geographical zone) received through the at least one radio receiver 2204 from the one or more other communication apparatuses under the control of the at least one controller 1506. The at least one transmission signal generator 2208 and the at least one receive signal processor 2210 may be stand-alone modules of the communication apparatus 2200 that communicate with the at least one controller 2206 for the above-mentioned functions, as shown in FIG. 22. Alternatively, the at least one transmission signal generator 2208 and the at least one receive signal processor 2210 may be included in the at least one controller 2206. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 2202, at least one radio receiver 2204, and at least one antenna 2212 may be controlled by the at least one controller 1506.

The communication apparatus 2200, when in operation, provides functions required for optimising time domain window and DMRS for joint channel estimation. For example, the communication apparatus 2200 may be a UE, and the circuitry 2214 may, in operation, determine one or more time domain windows for multiple physical uplink shared channel (PUSCH) transmissions, each length of the one or more time domain windows being not more than an overall length of the multiple PUSCH transmissions. The transmitter 2202 may, in operation, transmits reference signals based on the one or more time domain windows.

The circuitry 2214 and the transmitter 2202 may be further configured to generate and transmit respectively first reference signals of the reference signals in a first time domain window of the one or more time domain windows, as well as generate and transmit respectively second reference signals of the reference signals in a second time domain window of the one or more time domain windows, the first reference signals being different from the second reference signals. The circuitry 2214 and the transmitter 2202 may be further configured to generate and transmit respectively first reference signals of the reference signals within each length of the one or more time domain windows, as well as generate and transmit respectively second reference signals of the reference signals outside each length of the one or more time domain windows, the first reference signals being different from the second reference signals. The first reference signals and/or the second reference signals may be generated based on at least phase continuity and power consistency requirements. The first reference signals and the second reference signals may be generated based on a different phase and/or a different power.

Each length of the one or more time domain windows may be indicated by at least a downlink control information, an uplink control information, medium access control control element (MAC CE), or radio resource control (RRC). The uplink control information may be multiplexed in at least one of the multiple PUSCH transmissions. The transmitter 2202 may be further configured to transmit one or more subsequent PUSCH transmissions that are coherent with the at least one of the multiple PUSCH transmissions that carries the uplink control information.

Each length of the one or more time domain windows may be determined based from a subset of candidate lengths of a time domain window. Each length included in the subset may be a number from 2 up to a total number of the multiple PUSCH transmissions. Each length of the one or more time domain windows may be determined based on a combination of a first information indicating a number of PUSCH transmissions in the multiple PUSCH transmissions and a second information indicating the subset of lengths. The subset of lengths may be different based on a total number of the multiple PUSCH transmissions.

Each length of the one or more time domain windows may be included in a time domain resource allocation (TDRA) table. Each length of the one or more time domain windows may be different from one another. Each length of the one or more time domain windows may be different based on a total number of the multiple PUSCH transmissions. Each length of the one or more time domain windows may be determined based on a capability of the communication apparatus or a channel condition or profile, and is indicated to a gNB. Each length of the one or more time domain windows may be same as a length of an inter-slot frequency hopping. A length of an inter-slot frequency hopping may be a multiple of each length of the one or more time domain windows. Each length of the one or more time domain windows may be different from a length of an inter-slot frequency hopping.

The reference signals may be bundled based on each length of the one or more time domain windows. Each length of the one or more time domain windows may be a bundling size of the reference signals. Each length of the one or more time domain windows may be used in a same frequency allocation of a frequency hopping. Each length of the one or more time domain windows may be determined based on the number of symbols, slots, or repetitions allocated for the multiple PUSCH transmissions. Each length of the one or more time domain windows may be equal to the number of consecutive PUSCH transmissions from the multiple PUSCH transmissions. Each of the one or more time domain windows may be fixed or shifted in time domain with reference to an absolute timing.

The transmitter 2202 may be further configured to transmit a smaller number of the reference signals than that allocated by a gNB in one or more PUSCH transmissions within each length of the one or more time domain windows, wherein the smaller number of the reference signals is (pre-)configured. The transmitter may be further configured to transmit a greater number of the reference signals than that allocated by a gNB in one or more PUSCH transmissions within each length of the one or more time domain windows, wherein the greater number of the reference signals is (pre-)configured. The circuitry 2214 and the transmitter 2202 may be further configured to generate and transmit respectively the reference signals in a uniform pattern within each length of the one or more time domain windows. The circuitry 2214 may be further configured to apply a different precoding scheme for each of the one or more time domain windows. The circuitry 2214 may be further configured to assign each of the one or more time domain windows spatial information associated with one or more antennas or panels of the communication apparatus. The transmitter 2202 is further configured to transmit the reference signal after an offset period of at least one symbol or slot from the determination of the one or more time domain windows.

The communication apparatus 2200, when in operation, provides functions required for optimising time domain window and DMRS for joint channel estimation. For example, the communication apparatus 2200 may be a base station, and the circuitry 2214 may, in operation, determine one or more time domain windows for multiple physical uplink shared channel (PUSCH) transmissions, each length of the one or more time domain windows being not more than an overall length of the multiple PUSCH transmissions. The transmitter 2202 may, in operation, indicate the one or more time domain windows to one or more other communication apparatuses.

The receiver 2204 may, in operation, receive reference signals from a communication apparatus. The receiver 2204 may, in operation, further receive an uplink signal from the communication apparatus. The circuitry 2214 may, in operation, demodulate/decode the uplink signal based on the reference signals.

### (Control Signals)

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sidelink control information (SCI) or the 2nd stage SCI.

### (Base Station)

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

### (Uplink/Downlink/Sidelink)

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

### (Data Channels/Control Channels)

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

### (Reference Signals)

In the present disclosure, the reference signals are signals known to both a base station and a mobile station and each reference signal may be referred to as a Reference Signal (RS) or sometimes a pilot signal. The reference signal may be any of a DMRS, a Channel State Information-Reference Signal (CSI-RS), a Tracking Reference Signal (TRS), a Phase Tracking Reference Signal (PTRS), a Cell-specific Reference Signal (CRS), and a Sounding Reference Signal (SRS).

### (Time Intervals)

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

### (Frequency Bands)

The present disclosure may be applied to any of a licensed band and an unlicensed band.

### (Communication)

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

### (Antenna Ports)

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

As described above, the embodiments of the present disclosure provide an advanced communication system, communication methods and communication apparatuses for optimising time domain window and DMRS for joint channel estimation that advantageously maintains power consistency and phase continuity among PUSCH transmissions.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

Some non-limiting examples of such communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

Various embodiments of the present disclosure may be described in the form of the following statements:

### Statements

Statement 1. A communication apparatus comprising;
circuitry, which in operation, determines one or more time domain windows for multiple physical uplink shared channel (PUSCH) transmissions, each length of the one or more time domain windows being not more than an overall length of the multiple PUSCH transmissions; and
a transmitter, which in operation, transmits reference signals based on the one or more time domain windows.
   Statement 2. The communication apparatus of Statement 1, wherein the circuitry and the transmitter are further configured to generate and transmit respectively first reference signals of the reference signals in a first time domain window of the one or more time domain windows, as well as generate and transmit respectively second reference signals of the reference signals in a second time domain window of the one or more time domain windows, the first reference signals being different from the second reference signals.
   Statement 3. The communication apparatus of Statement 1, wherein the circuitry and the transmitter are further configured to generate and transmit respectively first reference signals of the reference signals within each length of the one or more time domain windows, as well as generate and transmit respectively second reference signals of the reference signals outside each length of the one or more time domain windows, the first reference signals being different from the second reference signals.
   Statement 4. The communication apparatus of Statement 1, wherein each length of the one or more time domain windows is indicated by at least a downlink control information, an uplink control information, medium access control control element (MAC CE), or radio resource control (RRC).
   Statement 5. The communication apparatus of Statement 1, wherein each length of the one or more time domain windows is determined based from a subset of candidate lengths of a time domain window.
   Statement 6. The communication apparatus of Statement 5, wherein each length included in the subset is a number from 2 up to a total number of the multiple PUSCH transmissions.
   Statement 7. The communication apparatus of Statement 5, wherein each length of the one or more time domain windows is determined based on a combination of a first information indicating a number of PUSCH transmissions in the multiple PUSCH transmissions and a second information indicating the subset of lengths.
   Statement 8. The communication apparatus of Statement 1, wherein each length of the one or more time domain windows is included in a time domain resource allocation (TDRA) table.
   Statement 9. The communication apparatus of Statement 5, wherein the subset of lengths is different based on a total number of the multiple PUSCH transmissions.
   Statement 10. The communication apparatus of Statement 1, wherein each length of the one or more time domain windows is different from one another.
   Statement 11. The communication apparatus of Statement 1, wherein each length of the one or more time domain windows is different based on a total number of the multiple PUSCH transmissions.
   Statement 12. The communication apparatus of Statement 1, wherein each length of the one or more time domain windows is determined based on a capability of the communication apparatus or a channel condition or profile, and is indicated to a gNB.
   Statement 13. The communication apparatus of Statement 1, wherein each length of the one or more time domain windows is same as a length of an inter-slot frequency hopping.
   Statement 14. The communication apparatus of Statement 1, wherein a length of an inter-slot frequency hopping is a multiple of each length of the one or more time domain windows.
   Statement 15. The communication apparatus of Statement 1, wherein each length of the one or more time domain windows is different from a length of an inter-slot frequency hopping.
   Statement 16. The communication apparatus of Statements 2 and 3, wherein the first reference signals and/or the second reference signals are generated based on at least phase continuity and power consistency requirements.
   Statement 17. The communication apparatus of Statements 2 and 3, wherein the first reference signals and the second reference signals are generated based on a different phase and/or a different power.
   Statement 18. The communication apparatus of Statement 1, wherein the reference signals are bundled based on each length of the one or more time domain windows.
   Statement 19. The communication apparatus of Statement 1, wherein each length of the one or more time domain windows is a bundling size of the reference signals.
   Statement 20. The communication apparatus of Statement 1, wherein each length of the one or more time domain windows is used in a same frequency allocation of a frequency hopping.
   Statement 21. The communication apparatus of Statement 1, wherein each length of the one or more time domain windows is determined based on the number of symbols, slots, or repetitions allocated for the multiple PUSCH transmissions.
   Statement 22. The communication apparatus of Statement 1, wherein each length of the one or more time domain windows is equal to the number of consecutive PUSCH transmissions from the multiple PUSCH transmissions.
   Statement 23. The communication apparatus of Statement 1, wherein each of the one or more time domain windows is fixed or shifted in time domain with reference to an absolute timing.
   Statement 24. The communication apparatus of Statement 1, wherein the transmitter is further configured to transmit a smaller number of the reference signals than that allocated by a gNB in one or more PUSCH transmissions within each length of the one or more time domain windows, wherein the smaller number of the reference signals is (pre-)configured.
   Statement 25. The communication apparatus of Statement 1, wherein the transmitter is further configured to transmit a greater number of the reference signals than that allocated by a gNB in one or more PUSCH transmissions within each length of the one or more time domain windows, wherein the greater number of the reference signals is (pre-)configured.
   Statement 26. The communication apparatus of Statement 1, wherein the circuitry and the transmitter are further configured to generate and transmit respectively the reference signals in a uniform pattern within each length of the one or more time domain windows.
   Statement 27. The communication apparatus of Statement 1, wherein the circuitry is further configured to apply a different precoding scheme for each of the one or more time domain windows.
   Statement 28. The communication apparatus of Statement 1, wherein the circuitry is further configured to assign each of the one or more time domain windows spatial information associated with one or more antennas or panels of the communication apparatus.
   Statement 29. The communication apparatus of Statement 4, wherein the uplink control information is multiplexed in at least one of the multiple PUSCH transmissions.
   Statement 30. The communication apparatus of Statement 29, where the transmitter is further configured to transmit one or more subsequent PUSCH transmissions that are coherent with the at least one of the multiple PUSCH transmissions that carries the uplink control information.
   Statement 31. The communication apparatus of Statement 1, wherein the transmitter is further configured to transmit the reference signal after an offset period of at least one symbol or slot from the determination of the one or more time domain windows.
   Statement 32. A communication method comprising:
determining one or more time domain windows for multiple PUSCH transmissions, each length of the one or more time domain windows being not more than an overall length of the multiple PUSCH transmissions; and
transmitting reference signals based on the one or more time domain windows.
   Statement 33. A communication method comprising:
receiving an indication of one or more time domain windows for multiple physical uplink shared channel (PUSCH) transmissions, each length of the one or more time domain windows being not more than an overall length of the multiple PUSCH transmissions; and
circuitry, which in operation, transmits reference signals based on the one or more time domain windows.
   Statement 34. A base station comprising:
circuitry, which in operation, determines one or more time domain windows for multiple physical uplink shared channel (PUSCH) transmissions, each length of the one or more time domain windows being not more than an overall length of the multiple PUSCH transmissions; and
a transmitter, which in operation, indicates the one or more time domain windows to one or more communication apparatuses.
   Statement 35. A communication method comprising:
determining one or more time domain windows for multiple physical uplink shared channel (PUSCH) transmissions, each length of the one or more time domain windows being not more than an overall length of the multiple PUSCH transmissions; and
indicating the one or more time domain windows to one or more communication apparatuses.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1-16. (canceled)

17. A communication apparatus, comprising;
circuitry, which, in operation, determines one or more time domain windows for multiple physical uplink shared channel (PUSCH) transmissions, each length of the one or more time domain windows being no more than an overall length of the multiple PUSCH transmissions; and
a transmitter, which, in operation, transmits reference signals based on the one or more time domain windows.

18. The communication apparatus of claim 17, wherein each length of the one or more time domain windows is indicated by radio resource control (RRC).

19. The communication apparatus of claim 17, wherein each length of the one or more time domain windows is determined from a subset of candidate lengths of a time domain window.

20. The communication apparatus of claim 19, wherein each candidate length included in the subset is a number from two up to a total number of the multiple PUSCH transmissions.

21. The communication apparatus of claim 17, wherein the one or more time domain windows include lengths different from one another.

22. The communication apparatus of claim 17, wherein each length of the one or more time domain windows is determined based on a capability of the communication apparatus.

23. The communication apparatus of claim 17, wherein each length of the one or more time domain windows is same as an inter-slot frequency hopping interval.

24. The communication apparatus of claim 17, wherein an inter-slot frequency hopping interval is a multiple of each length of the one or more time domain windows.

25. The communication apparatus of claim 17, wherein each length of the one or more time domain windows is different from an inter-slot frequency hopping interval.

26. The communication apparatus of claim 17, wherein each length of the one or more time domain windows is determined based on the number of symbols, slots, or repetitions allocated for the multiple PUSCH transmissions.

27. A communication method, comprising:
determining one or more time domain windows for multiple physical uplink shared channel (PUSCH) transmissions, each length of the one or more time domain windows being no more than an overall length of the multiple PUSCH transmissions; and
transmitting reference signals based on the one or more time domain windows.

28. A communication method, comprising:
receiving an indication of one or more time domain windows for multiple physical uplink shared channel (PUSCH) transmissions, each length of the one or more time domain windows being no more than an overall length of the multiple PUSCH transmissions; and
transmitting reference signals based on the one or more time domain windows.
